(19) United States
(12) Patent Application Publication
(10) Pub. No.: US 2003/0160872 A1
(43) Pub. Date: Aug. 28, 2003

(54) Image capture device

(76) Inventor: Chi Ping Yeung, Hong Kong (CN)

Correspondence Address: Kerry Sisselman, Concord Camera Corp., Suite 650N, 4000 Hollywood Blvd., Hollywood, FL, 33021, US

(21) Appl. No.: 10/372,153

(22) Filed: Feb. 21, 2003

Related U.S. Application Data
(60) Provisional application No. 60/356,594, filed on Feb. 22, 2002.

(51) Int. Cl. G03B 37/02

(52) U.S. Cl. 348/208.2; 396/20

(57) ABSTRACT

An image capture device is provided which includes a movable and rotatable lens barrel for changing the taking lens focus in close focus and far focus situations. Additionally, rotation of the lens barrel adjusts the exposure aperture to create different aperture sizes for close focus, infinity focus and flash image captures. Further, in one particular embodiment using an internal display, a diopter adjustment mechanism is provided. A diopter adjustment cam wheel includes a flange of progressively increasing height in contact with a pin on the housing of a display lens. An image on the display is reflected through the display lens to the viewfinder ocular lens. Rotating the cam wheel adjusts the height of the display lens to accommodate the focus for imperfect vision.

### PRIORITY

The present application claims priority from co-pending provisional patent application serial No. 60/356,594, Filed on Feb. 22, 2002 and entitled IMAGE CAPTURE DEVICE.

### FIELD OF THE INVENTION

The present invention relates to the field of image capture devices, and more particularly, to a method and apparatus for adjusting the functionality of an image capture device.

### BACKGROUND OF THE INVENTION

Image capture devices are known. There is a need for an image capture device that changes the focal length and aperture size for images captured at close focus, far focus and low light situations.

Additionally, there is a need for a method and apparatus to adjust the focus of an image sighted through the viewfinder to permit a user who wears glasses to individually adjust the focus of the viewed image.

These needs, and others, are met by the present invention.

### SUMMARY OF THE INVENTION

An image capture device is provided which includes, in a first embodiment, a movable and rotatable lens barrel for changing the taking lens focus in close focus and far focus situations. In another embodiment, rotation of the lens barrel adjusts the exposure aperture to create different aperture opening sizes for close focus, infinity focus and flash image captures. In one particular embodiment of the present invention, two pivotally mounted, spring biased aperture blades are forced together predetermined distances to create the exposure aperture opening therebetween.

In a further embodiment, a diopter adjustment mechanism for adjusting the focus of an internal display is provided. A diopter adjustment cam wheel includes a flange of progressively increasing height in contact with a pin on the housing of a display lens. An image on the display is reflected through the display lens to the viewfinder ocular lens. Rotating the cam wheel adjusts the height of the display lens to accommodate the focus for imperfect vision.

Other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

The foregoing summary, as well as the following detailed description of the preferred embodiments, is better understood when read in conjunction with the appended drawings. For the purpose of illustrating the invention, there is shown in the drawings an exemplary embodiment that is presently preferred, it being understood, however, that the invention is not limited to the specific methods and instrumentality's disclosed. In the drawings:

FIG. 1 is a front plan view of an image capture device in accordance with the present invention.

FIG. 2 is a rear plan view of the image capture device of FIG. 1.

FIG. 3 is a top plan view of the image capture device of FIG. 1.

FIG. 4 is a partial cutaway view of an image capture device including aperture adjustment mechanism in accordance with one specific embodiment of the present invention.

FIG. 5 is a diagram of the aperture adjustment mechanism of FIG. 4 in a first mode of operation.

FIG. 6 is a diagram of the aperture adjustment mechanism of FIG. 4 in a second mode of operation.

FIG. 7 is a diagram of the aperture adjustment mechanism of FIG. 4 in a third mode of operation.

FIG. 8 is a front plan partial view of a portion of the image capture device main body.

FIG. 9 is a perspective view of a lens barrel

FIG. 10 is a partial perspective view of a lens barrel seated in the image capture device main body.

FIG. 11 is a partial diagram of a diopter adjustment mechanism useful with one specific embodiment of the present invention.

FIG. 12 is a side view of the diopter adjustment mechanism of FIG. 11.

FIG. 13A is a front plan view of a diopter adjustment cam.

FIG. 13B is a perspective view taken from the rear of the diopter adjustment cam of FIG. 13A.

FIG. 14 is a partial side diagram of a diopter adjustment mechanism used in connection with another specific embodiment of the present invention.

### DETAILED DESCRIPTION OF THE PREFERRED EMBODIMENTS

Before explaining the disclosed embodiment of the present invention in detail, it is to be understood that the invention is not limited in its application to the details of the particular arrangement shown since the invention is capable of other embodiments. Also, the terminology used herein is for the purpose of description and not of limitation.

The present invention provides a diopter adjustment mechanism and method for a camera including an internal display. A lens coaxial with the optical axis between the display and the viewfinder ocular lens portion is adjusted in height by a diopter adjustment wheel to adjust the height of the lens over the display, to thus adjust the focus of the display for individual variations.

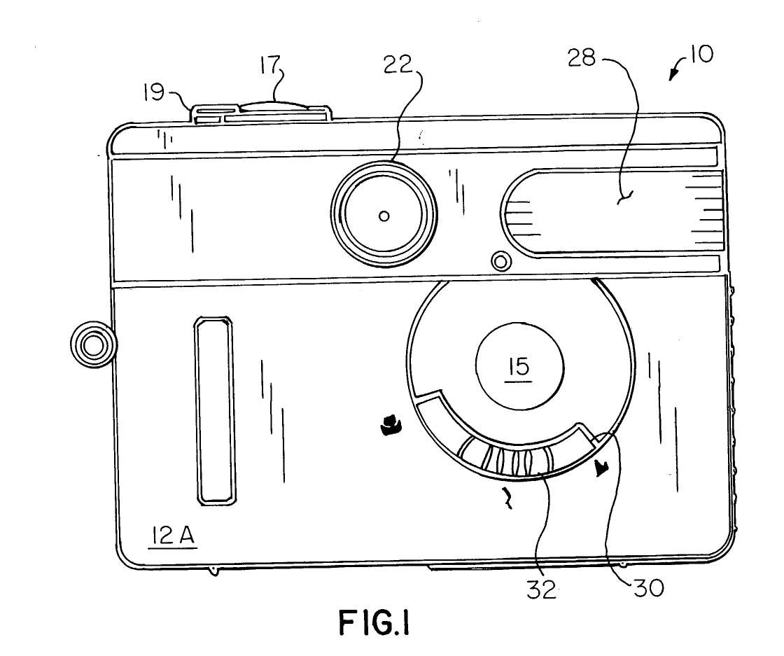

Referring now to FIGS. 1-3 there is shown an image capture device 10 suitable for embodying the present invention. The image capture device 10 includes an outer housing 11 having a front portion 12a and a back portion 12b. The front portion 12a and the back portion 12b are made as two separate pieces to facilitate manufacturing of the housing 11. It should be appreciated, however, that the housing 11 may, alternatively, be comprised of any number of pieces. Additionally, the outer surfaces of the front 12a and back 12b portions may be contoured, if desired, to improve gripping capabilities and provide a more ergonomic and aesthetically pleasing design. In the preferred embodiment, the housing 11 is constructed of a lightweight, yet rugged plastic material, but may, alternatively, be constructed of an alloy material, a metallic material or any other suitable material.

Front portion 12a of housing 11 is adapted for connective engagement with the corresponding back portion 12b using conventional fastening means. The two halves form a substantially light tight connection when assembled together.

The top and bottom halves 12a, 12b include a plurality of openings integrally formed therein. The openings include an objective aperture formed in a front face 12a of the housing 11. The objective aperture is disposed within the objective lens optical axis and is adapted for receiving and holding an objective lens cover 15. The objective lens cover 15 may be formed of a transparent material such as glass or plastic.

Image capture device 10 includes a taking lens 15 a physical trigger button 17. The image capture device 10 of the present embodiment additionally includes a viewfinder ocular lens 20 through which the user may frame an image to be captured. The present image capture device invention is particularly suited to an image capture device that can capture an image in digital form and provide it to a display incorporated as part of the image capture device 10. As will be described in connection with the individual embodiments below, one particular embodiment of the present invention includes an internal display for providing the digital image to the user. However, with other embodiments of the present invention, an external display may be used to review digital images and/or to frame the image to be captured.

The camera 10 of the present embodiment additionally includes a viewfinder objective lens 22 optically aligned with the viewfinder ocular lens 20. In an alternate embodiment, the viewfinder objective lens may be omitted and the viewfinder ocular lens 20 may be used to frame an image on the internal display, as with an internal electronic viewfinder.

The image capture device 10 additionally includes an LCD display 24 to provide a user with status information of the image capture device. Typical function selects include, on/off, timer on/off, etc. Additionally, the status LCD 24 may provide a variety of desired information including timer indication, battery status, and number of exposures remaining.

Alternately, the LCD may be omitted and the status information may be provided to the same display used to review an image, i.e., the internal display of the present embodiment. A directional pad 26 may be provided to assist the user in maneuvering through on screen display menus and/or through the images stored to memory.

Image capture device 10 additionally includes a mode select switch 32 which slides along a track 30 on the front face 12a thereof. The mode select switch 32 is set by the user to a desired mode based on ambient conditions. For example, the mode select switch 32 of the present embodiment can be set to a macro position, an inside position wherein the flash 28 is enabled, and an infinity setting.

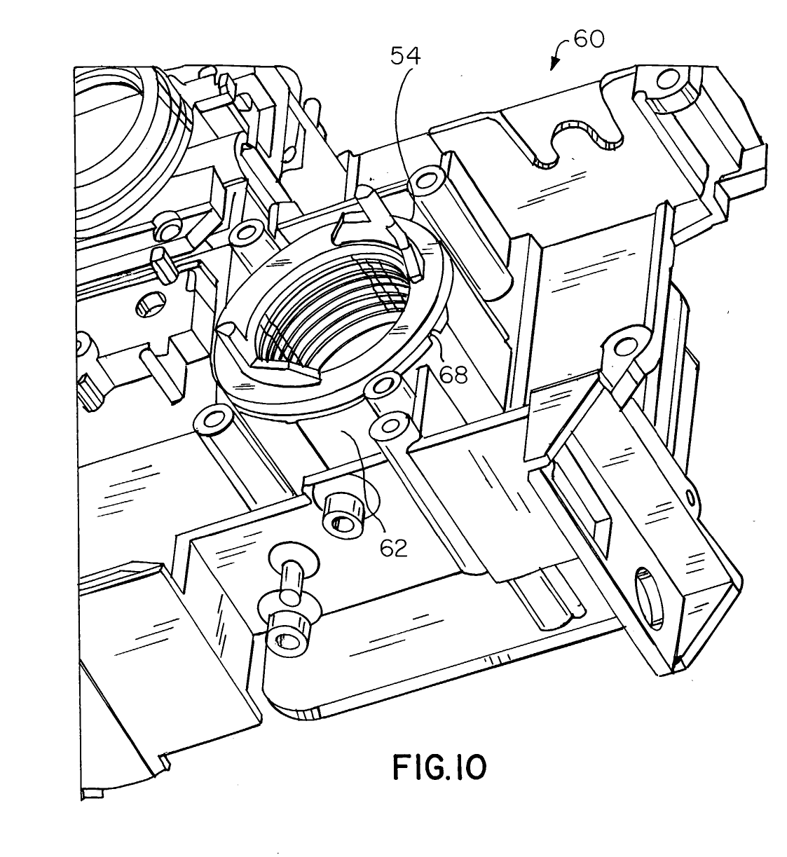

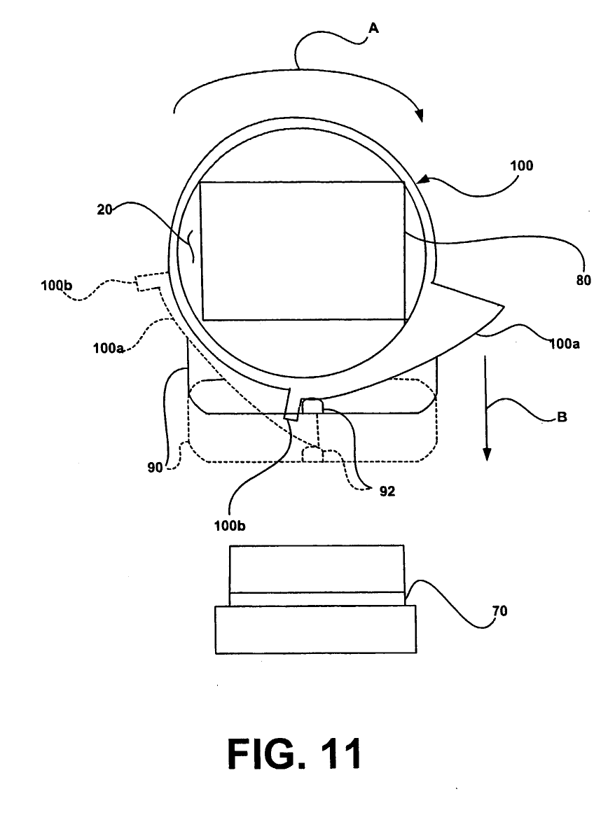

The present embodiment additionally includes a mirror slide switch 19 and a diopter adjust thumbwheel 14 through the rear housing 12b, as will be described more fully in connection with FIG. 11.

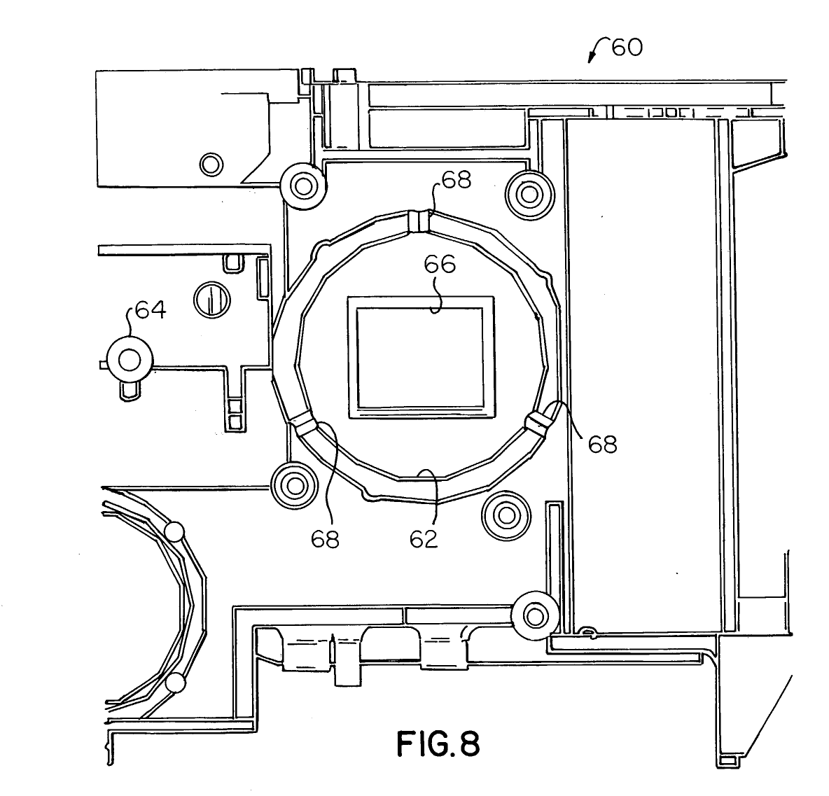

Referring now to FIGS. 4-7, there is shown a partial cut-away view of an image capture device 10 including an aperture adjustment mechanism 40 in accordance with one embodiment of the present invention. The aperture control mechanism 40 is mounted to the internal camera body and housed beneath the front cover 12a in alignment with the lens cover (15 of FIG. 1). The aperture adjustment mechanism 40 includes the aperture blades 44 and 46, which are pivotally mounted to the image capture device main body (60 of FIG. 8) by the pivot pin 42 which mates with a pivot pin aperture (64 of FIG. 8) in the image capture device main body. The free ends of the aperture blades 44 and 46 are normally biased away from each other by the coil spring 48 connected between the aperture blades at the ends secured by the pivot pin 42. In this arrangement, the aperture blades 44 and 46 are hinged at the pivot end. A securing mechanism 50 (which is part of a spring apparatus not shown) secures the aperture blades 44 and 46 within the same plane to maintain a fixed relationship between the blades 44 and 46. Additionally, aperture blade 44 includes a protuberance 44a that helps keep the aperture blade 46 in proper alignment with the aperture blade 44 when the blades 44 and 46 pivot relative to the pivot pin 42.

The inner surface edges 44b and 46b of the aperture blades 44 and 46 are formed such that at varying set positions, the inner surfaces 44b, 46b, form an aperture therebetween. This aperture is aligned with the lens 52, which underlies the aperture blades 44 and 46.

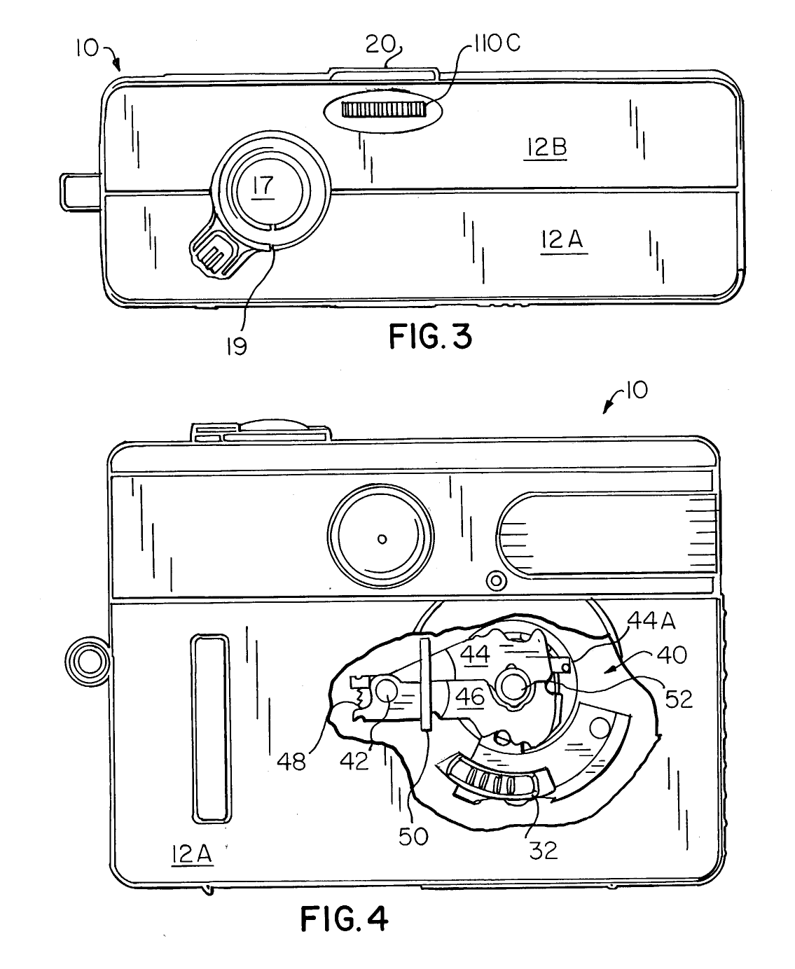

The lens 52 is maintained in a lens barrel 54 rotatably mounted in a corresponding cavity (62 of FIG. 8) in the image capture device main body (60 of FIG. 8). Disposed below the lens barrel 54 in optical alignment with the lens 52 is an image capture sensor (not shown). When the trigger button (17 of FIG. 3) is actuated, the image sensor captures an image detected through the lens 52 by light admitted through the aperture formed between aperture blades 44 and 46.

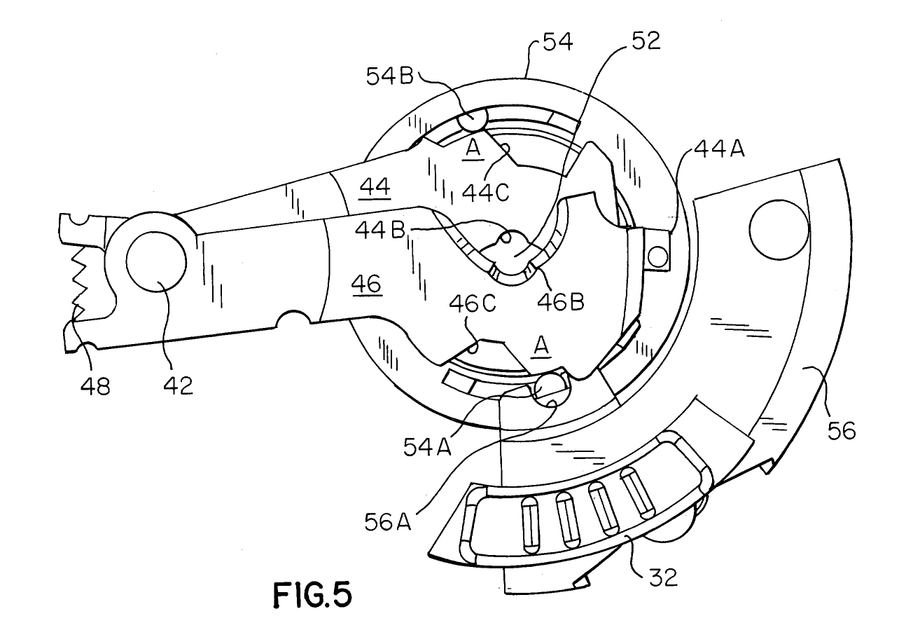

Referring more specifically to FIGS. 5-7, the lens barrel 54 includes two projections 54a and 54b. The lens 52 is immovably fixed into the lens barrel 54 so that the lens 52 and lens barrel 54 rotate as a unit. The mode select switch 32 accessible through the front face housing (12a of FIG. 4) of the image capture device 10 communicates with the switch body 56. Switch body 56 includes on its reverse face contact fingers (not shown) which close contacts on an underlying PC board to inform the image capture device processor of the position of the switch 32. The switch body 56 additionally includes a fork 56a formed therein. Fork 56a mates with the protuberance 54a so that when the mode switch 32 is slid from one position to another, the switch body 56 and fork 56a, physically rotate the lens barrel 54.

Because the aperture blades 44, 46 are spring biased apart by the coil spring 48, when the lens barrel 54 rotates, the outer surface edges 44c, 46c of the aperture blades 44, 46 are maintained in contact with the protuberances 54a, 54b. As such, when the lens barrel 54 is rotated, the protuberances 54a, 54b in contact with the outer surface edges 44c, 46c of the aperture blades 44, 46 define the total aperture opening over the lens 52.

Referring specifically to FIG. 5, there is shown an infinity setting position wherein the aperture over lens 52 is adjusted to its infinity setting. In this infinity setting, the protuberances 54a, 54b contact buttresses A on the aperture blades 44, 46, respectively to bias the blades 44, 46 toward each other a predetermined amount and to set the aperture opening therebetween to a predetermined size and shape.

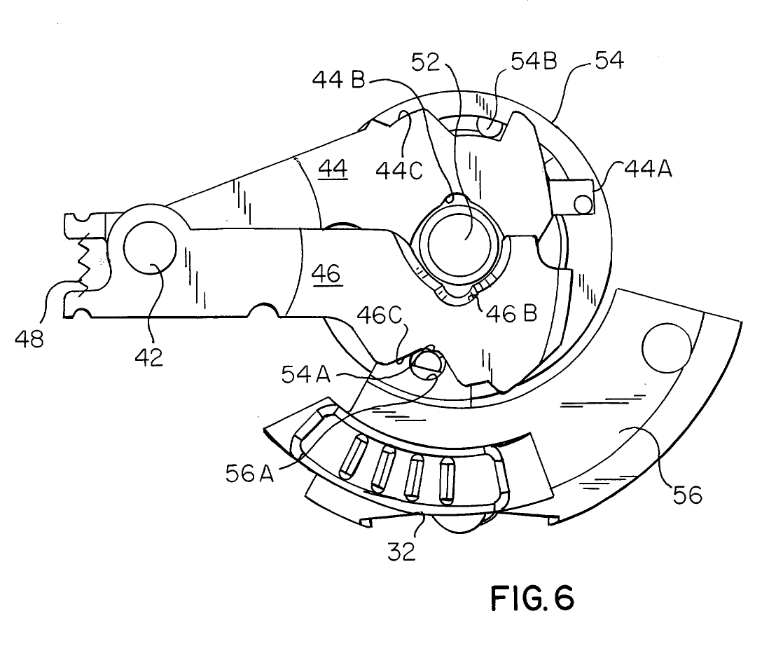

Similarly, referring to FIG. 6, there is shown an indoor or flash setting position wherein the aperture over the lens 52 is opened to its maximum amount to permit a maximum amount of light to enter the lens 52. In the indoor setting, the lens barrel 54 is rotated such that the protuberances 54a, 54b contact the surface edges 44c, 46c in a valley formed in the surface edge of the blades 44, 46, thus permitting the blades 44, 46 to be biased apart a maximum distance by the spring 48. This results in the greatest aperture distance between the inner surface edges 44b, 46b. Setting the mode switch 32 to the flash setting may additionally inform the processor to power and use the flash.

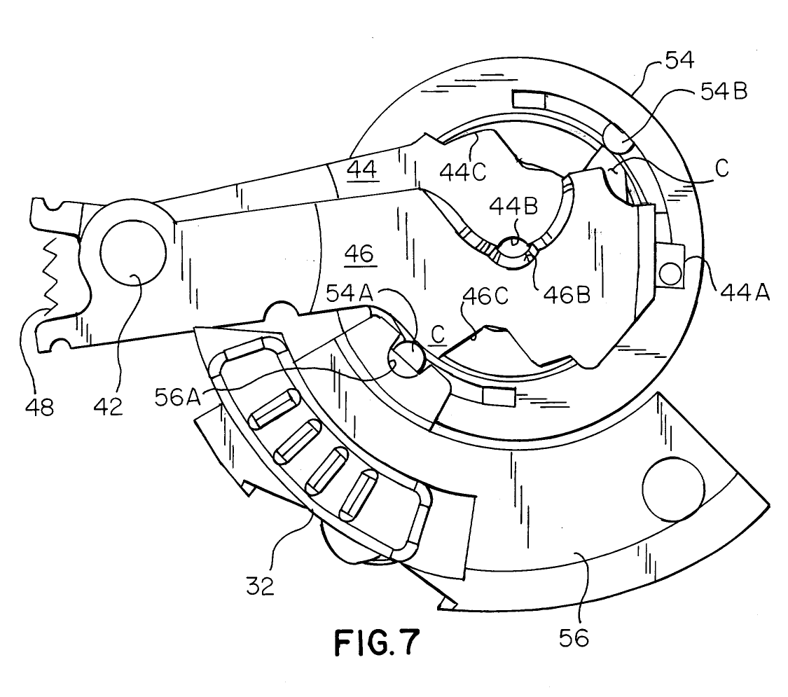

Referring specifically to FIG. 7, there is shown a macro or close setting of the aperture mechanism. In the macro setting, the lens barrel 54 is rotated such that the protuberances 54a, 54b contact buttresses C on the aperture blades 44, 46 to close the aperture formed by the inner surface edges 44b, 46b a predetermined amount. Note that the aperture size is smaller in the close setting than in the infinity setting, and both are smaller than the aperture size in the indoor setting.

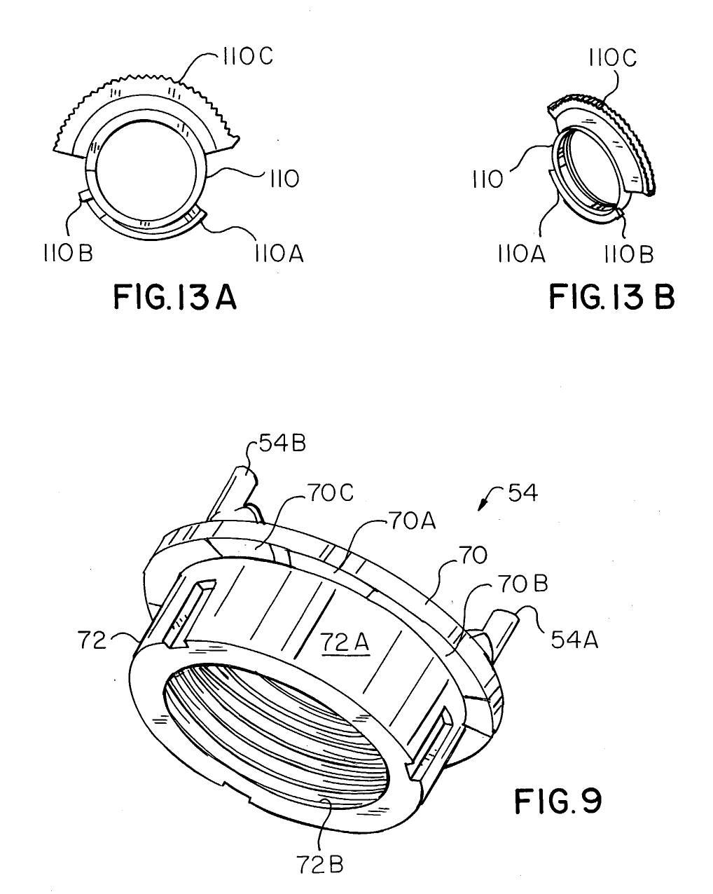

In addition to rotating, the lens 52 of the image capture device 10 moves up and down along the optical axis through the lens. Referring now to FIGS. 8-10, there is shown a portion of the image capture device main body 60 and the lens barrel 54. The image capture device main body 60 includes a lens barrel retaining aperture 62 having exposure opening 66 which is aligned over the image sensor (not shown) and three pins 68 formed on the upper surface of the retaining aperture 62.

The lens barrel 54 includes a cylindrical body 72 including an outer surface 72a and an inner threaded surface 72b. The lens 52 (not shown) may be screwed into the inner surface 72b of the body 72. A flange 70 surrounds the cylindrical body 72. This flange 70 contacts the upper surface of the retaining aperture 62 and, correspondingly, the three pins 68, when the lens barrel 54 is seated in the lens barrel-retaining aperture 62. Flange 72 includes several small stepped portions, including portions 70a, 70b and 70c, such that rotation of the lens barrel 54, as previously described moves the lens barrel 54 up and down along the optical axis corresponding to which portion of the flange 72 the pins 68 contact. In one particular embodiment of the present invention, the heights of the step portions of the flange vary by only about 0.02 mm to 0.08 mm. The lens barrel is spring biased against the upper surface of the retaining aperture 62 by a leaf spring (not shown). The tiny shift of lens 54 adjusts the shooting range from far away object range to close object range. Additionally, the lens barrel 54 includes the protuberances 54a and 54b, as described in connection with FIGS. 5-7.

Referring back to FIGS. 1-3, after an image is captured in response to actuation of the trigger button, it is stored in the image capture device 10. In one particular embodiment of the present invention, the stored image may be reviewed on an internal display using the viewfinder ocular lens 20. In an alternate embodiment, the image to be captured may additionally be framed using the internal display and the viewfinder ocular lens, if the viewfinder objective lens were omitted. In a system having an internal display, it is helpful to provide a diopter adjustment mechanism to assist the user who wears glasses to better focus the user's view of the internal display.

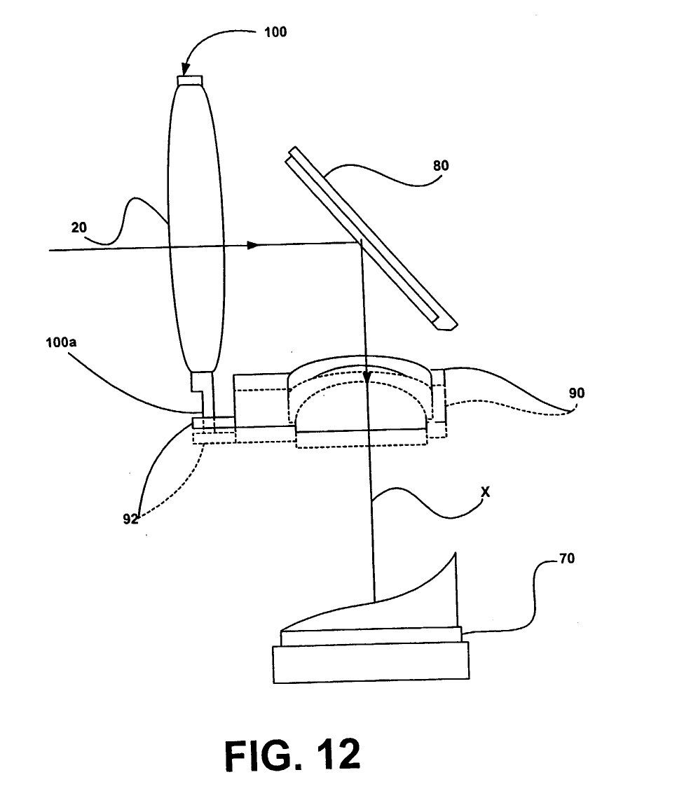

As such, in one particular embodiment of the present invention there is provided a diopter adjustment mechanism useful to provide a means to focus the internal display. Referring now to FIGS. 11 and 12, there is shown a diopter adjustment mechanism in accordance with one embodiment of the present invention. The image capture device 10 includes the viewfinder ocular lens 20 and an internal display 70. A mirror 80 is angled to reflect an image from the display 70 into the viewfinder ocular lens 20. A magnifying loupe lens 90 is disposed coaxially on the optical axis X between the viewfinder ocular lens 20 and the display 70, in alignment with the mirror 80. In the present embodiment, a diopter adjustment ring 100 encircles the viewfinder ocular lens 10.

The diopter adjustment cam wheel 100 includes a flange 100a. Flange 100a has a progressively increasing height measured from the flange edge to the center of the cam wheel and additionally includes the flange stop 100b, which prevents the diopter adjustment ring from being turned too far counterclockwise. Flange 100a is designed to engage a protuberance 92 on the housing of the magnifying loupe lens 90 and convert rotational motion of the diopter adjustment cam wheel 100 into linear movement of the magnifying loupe lens 90.

At rest, the magnifying loupe lens 90 is normally biased away from the display 70 and into contact with the flange 100a. As shown in shadow, when the diopter adjustment cam wheel 100 is turned in the direction of arrow A, the protuberance 92 follows the surface edge of the flange 100a and moves the magnifying loupe lens 90 in the direction of arrow B. As such the focus of the magnifying loupe lens 90, and thus the focus of the display 70, may be minutely adjusted by rotating the diopter adjustment ring about the optical axis.

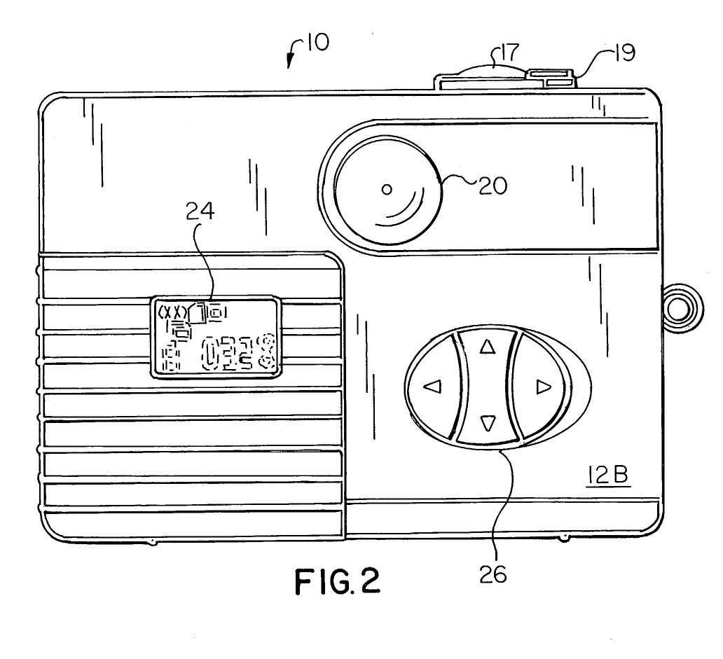

The diopter adjustment cam wheel can take many forms. For example, a cam wheel 100 as shown in FIG. 11 may be used and another ring or wiper that interlocks with the cam wheel 100 through the outer surface (12b of FIG. 2) may be slideably mounted to the outside surface 12b of the image capture device 10.

Referring now to FIGS. 13A and 13B there is shown one particular diopter adjustment cam wheel 110 used with one specific embodiment of the present invention. As with the diopter adjustment cam wheel 100 of FIG. 11, the diopter adjustment cam wheel 110 includes a flange 110a, which has a progressively increasing height measured from the flange edge to the cam wheel center. Optionally, flange 110a may include a flange stop 110b. Additionally, the diopter adjustment cam wheel 110 includes a thumbwheel portion 110c. Thumbwheel portion 110c may extend through the housing (11 of FIG. 2) of the image capture device 10 and be accessible to the user, as shown in FIG. 3.

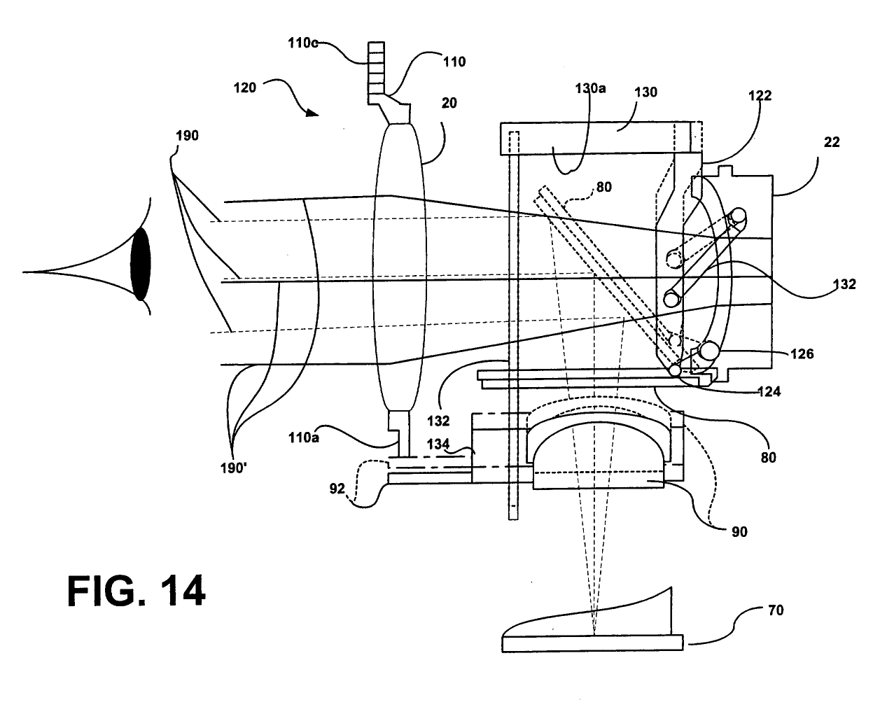

Referring now to FIG. 14 there is shown a diagram of another specific embodiment of the image capture device diopter adjustment mechanism of the present invention. The present diopter adjustment mechanism is integrated into an image capture device including a dual-purpose viewfinder assembly 120. The dual-purpose viewfinder assembly 120 of the present invention is moveable between a first live image or “shooting mode” (shown in solid lines) and a second stored image or “review mode” (shown in phantom). In the present embodiment, the viewfinder assembly 120 of the present embodiment is built around a simple reverse Galilean viewfinder. A positive ocular lens 20 is placed in direct physical and optical alignment with a negative objective lens 22. A flipping mirror 80 is disposed directly between the positive and negative lenses 20, 22.

The flipping mirror 80 is operated between a folded position and a raised position (shown in shadow) by a mirror plunger 122. Mirror plunger 122 includes an axial bore therethrough, which cooperates with a projection 124 on the mirror housing. The mirror housing additionally includes two pivot arms 126 that engage corresponding sleeve projections on the viewfinder housing (not shown), permitting the mirror 80 to pivot downward in response to depression of the mirror plunger 122.

A mirror slide switch (19 of FIGS. 1-3) provides an external user interface to manually switch the camera between the shooting and review modes. The sliding mirror switch engages an underlying review cam slide 130 of the viewfinder assembly 120. When first switched to the shooting mode, a first cam surface and bottom surface 130a of the review cam slide 130 engage and lock the mirror plunger 122 into its depressed position. Depression of the mirror plunger 122 folds the mirror 80 out of the view path and additionally stretches the linked coil spring 132. As such, the line of sight through the viewfinder is clear, following lines 190′ from the positive lens 20 through the negative lens 22.

When the switch (19 of FIGS. 1-3) is in the review mode position, a previously stored image can be reviewed on an internal microdisplay 70 from the ocular lens 20. In operation, when the switch (19 of FIGS. 1-3) is manually moved, the underlying review cam slide 130 releases the mirror plunger 122 and the coil spring 132 returns to its compressed state, thus raising the mirror 80 to its raised position (shown in shadow). In the raised position, the mirror 80 is angled at about 45 degrees. The viewfinder housing may include a mirror stop surface (not shown) to restrict the range of motion of the mirror 80 to ensure that the mirror 80 is held at the correct viewing angle.

In the present embodiment, a magnifying loupe 90 is disposed above a display 70 in a direct line with the mirror 80. In the review mode, images on the display 70 are magnified by the magnifying loupe 90, reflected from the mirror 80 and viewed through the positive lens 20 of the viewfinder. The line of sight through the viewfinder assembly 120 follows the path 190 in the review mode.

The magnifying loupe 90 may be fixed above the microdisplay a set distance to provide magnification for the image on the display 70. Alternatively, as shown in the current embodiment, a diving lens group 90 may be provided that moves the magnifying loupe 90 to make room for the flipping mirror 80 in its folded position. When depressed, the loupe barrel guide pin 132 engages the loupe lens group housing 134 and operates to move the loupe lens group into a storage position (shown in solid lines), towards the microdisplay 70. In the present embodiment the review cam slide 130 engages and locks the loupe barrel guide pin 132 when the slide plate 130 is moved into the shooting mode position. This makes room inside the viewfinder assembly 120 for the mirror 80, in its folded position. When the slide plate 130 is moved to the review mode position, the loupe barrel guide pin 132 is released and a coil spring (not shown) attached between the lens barrel housing 134 and the viewfinder housing returns the magnifying loupe 90 to the desired position (shown in shadow) above the microdisplay 70. Additionally, when in the desired review position (shown in shadow) the magnifying loupe lens pin 92 on the frame 134 of the magnifying loupe lens 90 is brought into contact with the flange portion 110a of a diopter adjustment cam wheel 110, such as the diopter adjustment cam wheel 110 of FIGS. 13A and 13b. In the review mode, when the thumbwheel portion 110c of the cam wheel 110 is manually adjusted, the flange 110a adjusts the height of the magnifying loupe lens 90 over the display 70 for fine tuning the focus of the display 70 at the viewfinder ocular lens. When the mirror 80 and the magnifying loupe lens 90 are in the stored position, the pin 92 is withdrawn with the loupe lens 90. As such, in the stored position, the pin 92 is no longer in contact with the flange 110a of the cam wheel 110 and turning the cam wheel 110 has no effect on the view through the viewfinder 20,22.

While the invention has been described with reference to a preferred embodiment, it will be understood by those skilled in the art that various changes may be made and equivalents may be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An image capture device, comprising:
a front cover including a light pass aperture therethrough;
a rear cover engaged with said front cover in a light tight fashion;
an internal body disposed between said front cover and said rear cover, said internal body including a lens aligned with said light pass aperture and concentric with the optical axis;
an aperture control mechanism disposed between said internal body and said front cover, including,
a first aperture blade having a first fixed end and a first free end separated on one edge by a first inner surface, said first aperture blade being pivotally connected to said internal body at a pivot point near said first fixed end,
a second aperture blade disposed in overlapping scissor fashion with said first aperture blade, said second aperture blade having a second fixed end and a second free end separated on one edge by a second inner surface, said second aperture blade being additionally, pivotally connected to said internal body at said pivot point,
at least one spring connected to said first and second aperture blades to bias said first free end and said second free end normally apart, and
wherein at least a portion of said first inner surface near the first free end and at least a portion of said second inner surface near the second free end are shaped to form an aperture therebetween when said first and second free ends overlap a predetermined amount, said aperture being aligned with said lens, and
a switch controlling said aperture control mechanism such that, when said switch is located in a first switch position, said aperture formed by said first and second inner surfaces is of a first size and when said switch is actuated to a second switch position, said aperture formed by said first and second inner surfaces is of a second size different from said first size.

2. The image capture device of claim 1, wherein said first fixed end and said first free end are additionally separated by a first outer edge, said first outer edge being contoured to include at least a first set position and a second set position, wherein actuation of said switch between said first switch position and said second switch position moves said first aperture blade with respect to said second aperture blade and changing the size of said aperture.

3. The image capture device of claim 2, wherein actuation of said switch between said first switch position and said second switch position causes a first protuberance to slide between said first set position and said second set position of said first outer edge, moving said first aperture blade with respect to said second aperture blade and changing the size of said aperture.

4. The image capture device of claim 2, wherein said second fixed end and said second free end are additionally separated by a second outer edge, said first outer edge being contoured to include at least a first set position and a second set position, wherein actuation of said switch between said first switch position and said second switch position moves said first aperture blade and said second aperture blade simultaneously with respect to each other, changing the size of said aperture.

5. The image capture device of claim 4, wherein actuation of said switch between said first switch position and said second switch position causes a second protuberance to slide between said first set position and said second set position of said second outer edge, wherein said first aperture blade and said second aperture blade are moved simultaneously with respect to each other, changing the size of said aperture.

6. The image capture device of claim 3, wherein at least one of said first set position and said second set position is one of a buttress and a valley formed in said first outer edge.

7. The image capture device of claim 6, including at least a third switch position and at least a third set position.

8. The image capture device of claim 6, wherein said first set position is a buttress and said second set position is a valley.

9. The image capture device of claim 5, wherein said first set position of said first outer edge and said first set position of said second outer edge are buttresses formed by said first and second outer edges.

10. The image capture device of claim 9, wherein said second set position of said first outer edge and said second set position of said second outer edge are valleys formed by said first and second outer edges.

11. The image capture device of claim 3, wherein said internal body additionally includes a retaining aperture and a rotatable barrel seated therein, said lens disposed in said rotatable barrel, said rotatable barrel additionally including said first protuberance wherein actuation of said switch causes said barrel to rotate and said first protuberance to slide along said first outer surface.

12. The image capture device of claim 5, wherein said internal body additionally includes a retaining aperture and a rotatable barrel seated therein, said lens disposed in said rotatable barrel, said rotatable barrel additionally including said first protuberance and said second protuberance, wherein actuation of said switch causes said barrel to rotate and said first protuberance to slide along said first outer surface and said second protuberance to slide along said second outer surface.

13. The image capture device of claim 12, wherein said internal body additionally includes a plurality of raised portions around the periphery of said retaining aperture and wherein said rotatable barrel includes a flange there round, said flange including a plurality of stepped portions on the bottom surface which contact said raised portions, such that rotation of said rotatable barrel moves said rotatable barrel along said optical axis.

14. An image capture device, comprising:
a front cover including a light pass aperture therethrough;
a rear cover engaged with said front cover in a light tight fashion;
an internal body disposed between said front cover and said rear cover, said internal body including,
a retaining aperture,
a plurality of raised portions surrounding said retaining aperture, and
a rotatable lens barrel including a flange there round, said lens barrel including a lens aligned with said light pass aperture and concentric with the optical axis, the bottom surface of said flange including a plurality of stepped portions in contact with said plurality of raised portions, such that rotation of said rotatable lens barrel moves said lens along said optical axis;
an aperture control mechanism disposed between said internal body and said front cover, including,
a first aperture blade having a first fixed end and a first free end separated on one edge by a first inner surface, said first aperture blade being pivotally connected to said internal body at a pivot point near said first fixed end,
a second aperture blade disposed in overlapping scissor fashion with said first aperture blade, said second aperture blade having a second fixed end and a second free end separated on one edge by a second inner surface, said second aperture blade being additionally, pivotally connected to said internal body at said pivot point,
a spring connected between said first and second aperture blades to bias said first free end and said second free end normally apart, and
wherein at least a portion of said first inner surface near the first free end and at least a portion of said second inner surface near the second free end are shaped to form an aperture therebetween when said first and second free ends overlap a predetermined amount, said aperture being aligned with said lens, and
a switch controlling said aperture control mechanism, wherein said switch is coupled with said rotatable lens barrel, such that moving said switch between a first switch position and a second switch position rotates said rotatable lens barrel and moves said lens along said optical axis, and additionally changes said aperture formed by said first and second inner surfaces between a first size and a second size different from said first size.

16. The image capture device of claim 14, wherein said rotatable lens barrel additionally includes a first protuberance and wherein said first fixed end and said first free end are additionally separated by a first outer edge, said first outer edge being contoured to include at least a first set position and a second set position, wherein actuation of said switch between said first switch position and said second switch position causes said first protuberance to slide between said first set position and said second set position of said first outer edge, moving said first aperture blade with respect to said second aperture blade and changing the size of said aperture.

17. The image capture device of claim 16, wherein said rotatable lens barrel additionally includes a second protuberance and wherein said second fixed end and said second free end are additionally separated by a second outer edge, said first outer edge being contoured to include at least a first set position and a second set position, wherein actuation of said switch between said first switch position and said second switch position causes said second protuberance to slide between said first set position and said second set position of said second outer edge, wherein said first aperture blade and said second aperture blade are moved simultaneously with respect to each other, changing the size of said aperture.

18. A diopter adjustment mechanism for an image capture device, comprising:
an ocular lens;
a display in optical alignment with said ocular lens via an optical path;
a diopter adjustment cam disposed concentrically around said ocular lens, said diopter adjustment cam including
a flange of progressively increasing height around at least a portion of said diopter adjustment cam, and
a thumbwheel mechanism sized to extend through the outer housing of the image capture device, said thumbwheel mechanism integrated with said diopter adjustment cam at a portion of said diopter adjustment cam not including said flange;
a magnifying loupe disposed in said optical path, said magnifying loupe including a protuberance in communication with said flange; and
wherein radial motion of said diopter adjustment cam results in linear movement of said magnifying loupe.

19. The diopter adjustment mechanism of claim 18, wherein said optical path is a bent optical path.

20. The diopter adjustment mechanism of claim 19, wherein the image capture device includes a viewfinder and said ocular lens is the ocular lens of said viewfinder, said diopter adjustment mechanism further including a movable mirror selectively disposed in front of said viewfinder ocular lens to create said bent optical path.
